(19) United States
(12) Patent Application Publication
(10) Pub. No.: US 2006/0094477 A1
(43) Pub. Date: May 4, 2006

(54) Power saving system and method

(75) Inventors: Carlos A. Rivera-Cintron, Lake Worth, FL (US); Daniel A. Baudino, Lake Worth, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/981,234

(22) Filed: Nov. 4, 2004

(51) Int. Cl. H04B 1/38

(52) U.S. Cl. 455/574

(57) ABSTRACT

A power saving method (10) in a wireless device having a short range communication link with a host device can include the steps of establishing the short range communication link with the host device (14), establishing at least one function of the wireless device in the host device (16), and transferring (38) the at least one function of the wireless device to the host device upon a predetermined event if a power saving opportunity is determined. If no power saving opportunity is determined, then processing (26) of the at least one function can be retained at the wireless device. The method can further include the step of sending (32) a request by the wireless device to the host device for handling the predetermined event and transferring the at least one function if the request is accepted.

### FIELD OF THE INVENTION

This invention relates generally to power saving techniques, and more particularly to a method and system for power savings techniques for mobile or portable devices.

### BACKGROUND OF THE INVENTION

Many portable communication products such as cellular phones are now incorporating short range communication links with host devices. For example, a cellular phone can communicate via a short range communication system such as Bluetooth to enable hands-free operation via a vehicle's stereo system for safety concerns. Such a transfer of functionality is not being done for the purpose of battery savings at the portable communication device. In many instances, the portable communication products have a limited power supply using battery packs that are typically rechargeable. Battery drain and battery life in portable communication products are issues that users and product designers alike contend with every day. The host devices on the other hand are typically coupled to more substantial power supplies and usually have no power supply limitation issues. For example, a stereo system in a vehicle can typically rely on a large power supply in the form of a 12 volt battery and a generator.

Some of the functionality in a portable communication product is able to be repeated or simulated at a host device. In certain instances, these reproducible functions are functions that significantly drain the power available at a portable communication product, yet no existing portable communication product transfers these functions to a host device for the purpose of battery savings at the portable communication product and enables the portable communication product to regain control of all their functions once out of the short range communication link.

### SUMMARY OF THE INVENTION

In a first embodiment of the present invention, a power saving method in a wireless device having a short range communication link with a host device can include the steps of establishing the short range communication link with the host device, establishing at least one function of the wireless device in the host device, and transferring the at least one function of the wireless device to the host device upon a predetermined event if a power saving opportunity is determined. The method can further include the step of processing the at least one function at the host device and retaining and processing the at least one function at the wireless device if no power saving opportunity is determined. The method can further include the step of sending a request by the wireless device to the host device for handling the predetermined event and transferring the at least one function if the request is accepted. The method can also include the step of transferring the at least one function from the host device back to the wireless device once the wireless device is out of range of the short range communication link with the host device. In one alternative, the method can further include the steps of establishing at least one function of the wireless device with two or more host devices and determining which of the two or more host devices are most capable of processing the at least one function.

In a second embodiment of the present invention, a wireless device can include a transceiver for a short range communication link with a host device and a processor coupled to the transceiver. The processor can be programmed to establish the short range communication link with the host device, establish at least one function of the wireless device in the host device, and transfer the at least one function of the wireless device to the host device upon a predetermined event if a power saving opportunity is determined. The processor can be further programmed to enable the processing of the at least one function at the host device, to retain and to process the at least one function at the wireless device if no power saving opportunity is determined. The processor can be further programmed to send a request to the host device to handle the predetermined event and transfer the at least one function if the request is accepted by the host device. The processor can be further programmed to enable the transfer of the at least one function from the host device back to the wireless device once the wireless device is out of range of the short range communication link with the host device. Note the wireless device can be any among a cellular phone, a two-way pager, a messaging device, a trunked radio, a smart phone, a satellite phone, a laptop computer, a portable home appliance, a portable personal hygiene appliance, or any combination thereof. The host device can be any device among a personal computer, a vehicle, or an electronic device coupled to a fixed power source. The host device can have at least one function capability among audio, display, and user input. Further note that the short range communication link with the host device can be at least one among a Bluetooth communication link, an infrared communication link, or an 802.15.4 communication link for example. In one embodiment the processor can be further programmed to establish at least one function of the wireless device with two or more host devices and the processor can also be programmed to determine which of the two or more host devices are most capable of processing the at least one function.

In a third embodiment of the present invention, a power saving system for a portable electronic product can include a transceiver for a short range communication link with a host device and a processor coupled to the transceiver. The processor can be programmed to establish the short range communication link between the portable electronic product and the host device, establish at least one function of the portable electronic product in the host device, and transfer the at least one function of the portable electronic product to the host device upon a predetermined event if a power saving opportunity is determined.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart illustrating a power saving method in accordance with an embodiment of the present invention.

FIG. 2 is another chart illustrating the operation of a wireless device and a host device in accordance with an embodiment of the present invention.

FIG. 3 is a timing diagram illustrating a beaconing mode used by a wireless device and a host device in accordance with an embodiment of the present invention.

FIG. 4 is a timing diagram illustrating a polling mode of wireless device in accordance with an embodiment of the present invention.

FIGS. 5 and 6 are flow charts illustrating a power saving method by a host device in accordance with an embodiment of the present invention.

FIGS. 7 and 8 are flow charts illustrating a power saving method by a wireless communication device in accordance with an embodiment of the present invention.

### DETAILED DESCRIPTION OF THE DRAWINGS

Using a short range wireless link such as Bluetooth, 802.15.4, or infrared (IR), a portable communication device such as cellular phone or other portable electronic device can take advantage of a more efficient electrical power scheme by taking advantage of a host device's power source in accordance with an embodiment of the invention. The host device can be a personal computer, a vehicle or just about any appliance plugged into a power outlet or power source. In this scenario, the cellular phone and the host device can communicate via a simple protocol to allow the host device to ring for the cellular phone or perform other functions at the host device that typically drains the cellular phone's battery. This arrangement will substantially increase the battery life of the phone.

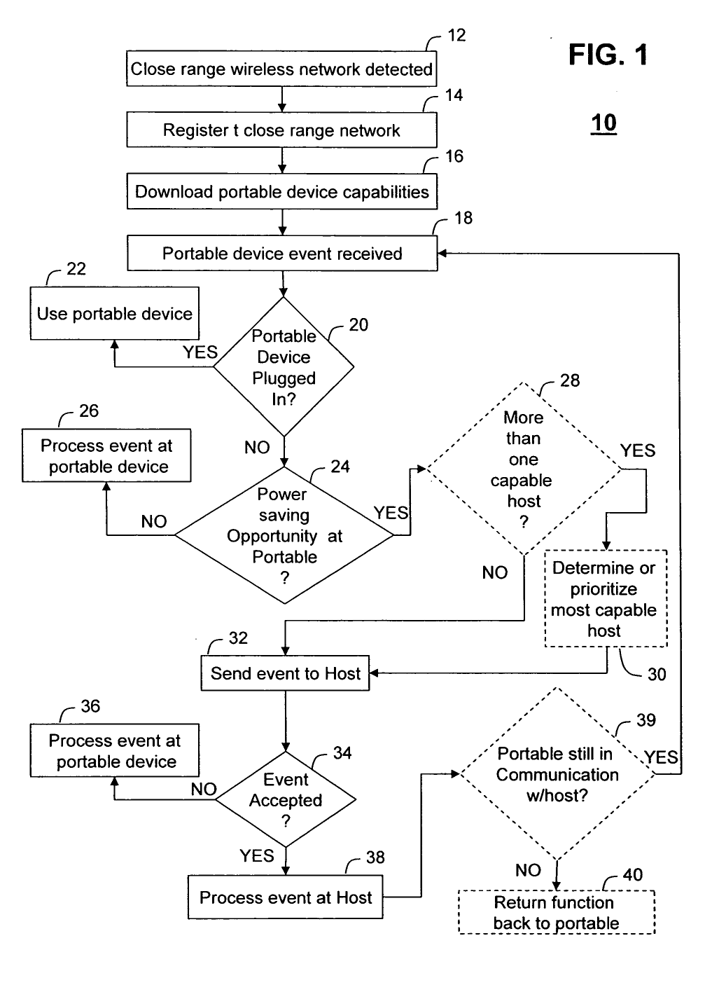

Referring to FIG. 1, once the portable communication device enters an area where the host device (both devices detected via close range wireless network at step 12) is present, the portable communication device registers at step 14 and can then download its capabilities to the host device at step 16. Some of the capabilities that can be performed at the host that would save power at the portable wireless device include an audio function for providing ringing, a display function for displaying information, and a keyboard or keypad function for user input.

Once an event is triggered on the portable communication device (e.g., ringing event when the device is receiving a call) at step 18, the system can detect if the portable communication device is plugged in at decision block 20. If the portable communication device is plugged in, then the functions are used at the portable communication device as usual at step 22. If the portable communication device is not plugged in, then it detects if the event received has any power saving opportunity (such as a remote ringer) at decision block 24. If no power saving opportunity is found at decision block 24, then the event is processed as usual at the portable communication device at step 26. Optionally, if there is a power saving opportunity, the method 10 can further determine if more than one host device is capable of processing the function at decision block 28 and a determination can be made as to which host device is most capable to process such function at step 30. Once again, if there is a power saving opportunity, the portable communication device can send a message to the host or remote device (assuming that the device is capable to reproduce the ring or perform any other desired function) at step 32. To determine the capability at the time of the event, the host device can be queried at decision block 34 to determine if the event is accepted. If the device is not capable (momentarily disabled, lacking sufficient data, lacking sufficient power, etc) it sends a message back to the originator rejecting the event and proceeds to process the event at the portable communication device at step 36. If not, the host device can send a message to the originator accepting the event and the event can be processed at the host device at step 38 in order to save power at the portable communication device. Furthermore, the method can also include the step of transferring the at least one function from the host device back to the wireless device at step 40 once the wireless device is out of range of the short range communication link with the host device as determined at decision block 39.

As noted above, if the portable communication device detects more than one device, the message is sent to the most capable (assuming that there is more than one device that is capable of doing the same thing). Alternatively, a priority can be assigned on the portable communication device or the host device.

In yet another alternative, the portable communication device and the host device can interchange capabilities as needed and then use such capabilities to generate events such as inputs. For example, if a computer serving as a host detects that an authorized cell phone (as the portable communication device) enters the area, the computer can generate phone calls using the keypad/display and then use the phone to route the calls.

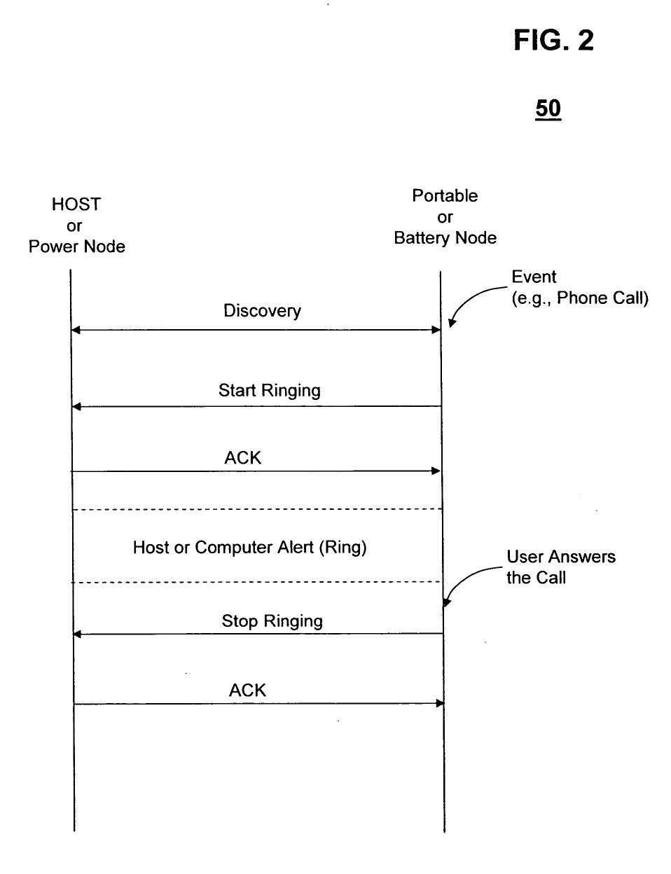

In accordance with embodiments herein, the host device can generally process any event that can save power for the portable communication device. Examples can include ringing, key presses (where there would be no need to turn light(s) on or off or display(s) on or off on the portable communication device), display events (assuming that the data communication consume less power than attending the event locally on the portable communication device), and any other power saving events. Similar concept can be used to attend events remotely that improve the quality as well as improve the power consumption profile at the portable communication device. For example, if the handheld device has MP3 or video capabilities, the audio or video can be routed to a system that can play in stereo, and amplified audio and larger viewing area. Referring to FIG. 2, a simple example for phone ringing is illustrated in the form of a time line. A power node at the host and a battery node at a portable communication device register with each other and each discover an event (such as a phone call). The host can start ringing and the host can acknowledge this action back to the portable communication device. Once the user answers the phone (either at the portable communication device or the host device), the ringing is stopped and another acknowledgement can be sent back the portable communication device.

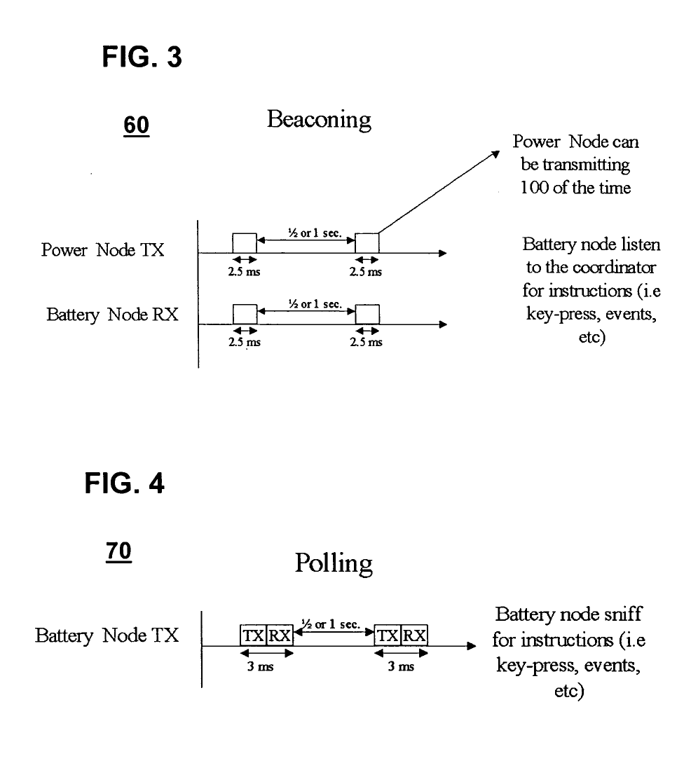

To illustrate the viability of the power savings described above for a portable communication device such a cellular phone, timing charts 60 and 70 of FIGS. 3 and 4 respectively show the beaconing and polling functions using in the 802.15.4 protocol. Using this protocol, the host or power node can be transmitting 100% of the time if desired while the portable communication device or battery node listens (at predetermined intervals) to the host for instructions such as key presses or other events as shown in FIG. 3. Also, during polling, the portable communication device or battery node can poll or sniff for instructions at predetermined intervals as shown in FIG. 4. The transmit and receive current used in this protocol has been estimated at 50 mA maximum. The signal timing is for a worst case scenario. The active current used by typical cellular phone audio and lights range around 200 mA for audio (at maximum volume) and 120 mA for activity lights such as keypad and display lights. These numbers are based on the WLAN/GSM subscriber platform, but may vary slightly for other platform products.

Thus, an analysis of the power savings when receiving a call is as follows:

Portable Communication Device Or Battery Node With Power Saving Method

Phone rings:
   main processor starts running (180 mA)
   low range radio frequency (RF) kicks in (50 mA)
This current drain happens at 2.5 ms intervals, every second as illustrated in FIG. 3. Given this scenario, the actual current drain is more accurately represented as:
Processor: 180 mA@<10%=18 mA (processor is active for the duration of the transmission/reception period, plus some overhead. Savings are also incurred by the fact that digital signal processor (DSP) is not playing audio alert).
RF: 50 mA@<1%=0.5 mA (based on 802.15.4 worst case)
Audio: 200 mA@0%=0 mA
Lights—120 mA@0%=0 mA
Total current drain considering duty cycle=18.5 mA

In contrast:

Portable Communication Device Or Battery Node Without Power Saving Method

Phone rings:
   activity lights run (120 mA) (constantly on for predetermined time after ringing)
   main processor starts running (180 mA, which might include DSP playing the audio alert signal)
   audio is turned on to allow audio alert (200 mA)
Assume that this scenario occurs with a 50% duty cycle (alert 1 second on, 1 second off, until the user picks up the call or it gets disconnected) and a more representative current drain is noted as:
Processor 180 mA@50%=90 mA (processor may sleep in between rings)
Audio 200 mA@50%=100 mA (rings are 1 second on, 1 second off)
Lights 120 mA@100%=120 mA (always on until activity lights are scheduled to turn off)
Total current drain considering duty cycle=310 mA.

Thus, there exists a theoretical savings of 310 mA−18.5 mA=292 mA when using the host or power saving node when receiving a phone call. Also note that a less, but still very quantifiable savings can be realized when dialing a call from the host or power savings node. Also note that additional considerations must be taken such as the time the phone actually rings, the number of calls per day, whether a user selects to associate to a host or power node upon proximity or upon receiving call, among other use scenarios that affect power consumption over time.

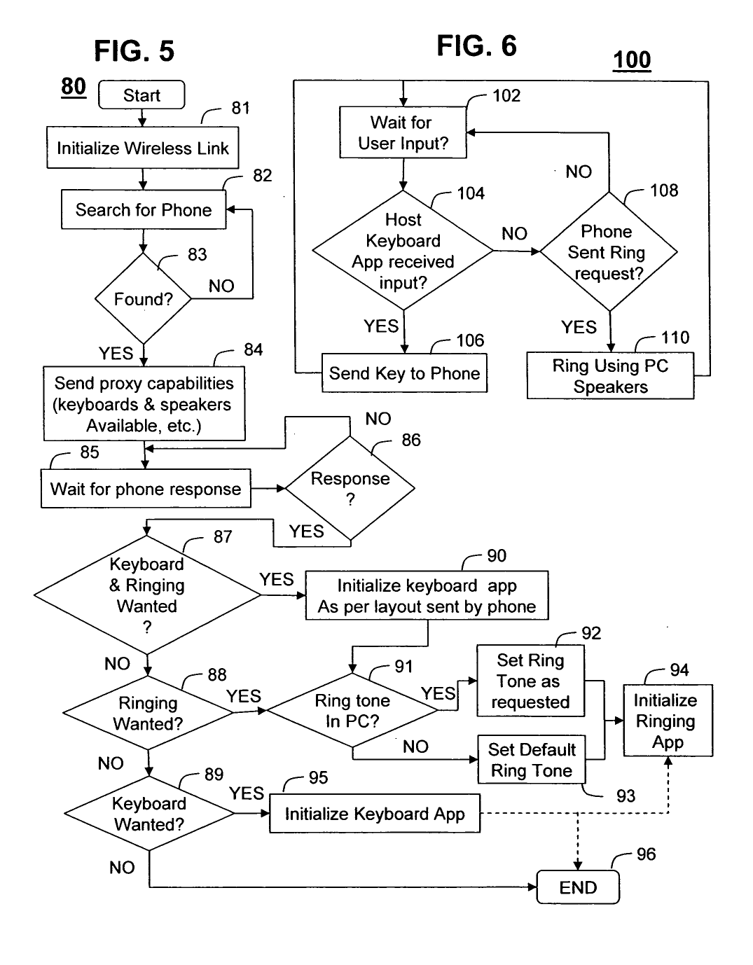

Referring to FIGS. 5 and 6, flow charts illustrate power saving methods 80 and 100 by a host device and a phone in accordance with an embodiment of the present invention. A wireless link can be initialized at step 81 between the host device (such as a personal computer) and a phone and a search for the phone is started at step 82. At decision block 83, the method 80 continues to search for the phone and otherwise if the phone is found, then proxy capabilities (such as keyboards, speakers available, microphones, displays, etc.) are sent to the phone at step 84 and a response is awaited at step 85. Until a response is received at the host at decision block 86, the host continues to wait for a response at step 85. Once a response is received, decision blocks 87, 88, and 89 determine whether the phone desires the host to remotely perform phone functions utilizing the host's keyboard and ringing (speaker), or just the ringing, or just the keyboard respectively. If the ringing and keyboard are desired at decision block 87, then a keyboard application is initialized at the host using a suitable layout sent by the phone at step 90. At decision block 91, if a particular ring tone requested by the phone is in the host device, then the ring tone is set as requested at step 92 and otherwise a default ring tone is set at step 93. Subsequently the ring tone application is initialized at step 94. If only the keyboard is desired at decision block 89, then the keyboard application is initialized at step 95 at the host and the method either ends at step 96 or alternatively also initializes the ringing application (possibly without actually activating the audio). If none of the capabilities are desired after decision blocks 87, 88 and 89, then the method 80 ends at step 96. Referring to FIG. 6, the method 100 awaits for user input at step 102. If the host keyboard application receives an input at decision block 104, then the corresponding key is sent to the phone at step 106 and the method continues to wait for additional user input. If no host keyboard input is received at decision block 104, then it is determined if the phone sent a ring request at decision block 108. If no ring request was sent, then the method 100 continues to await for additional input. If a request was sent, then ringing occurs using the host device at step 110.

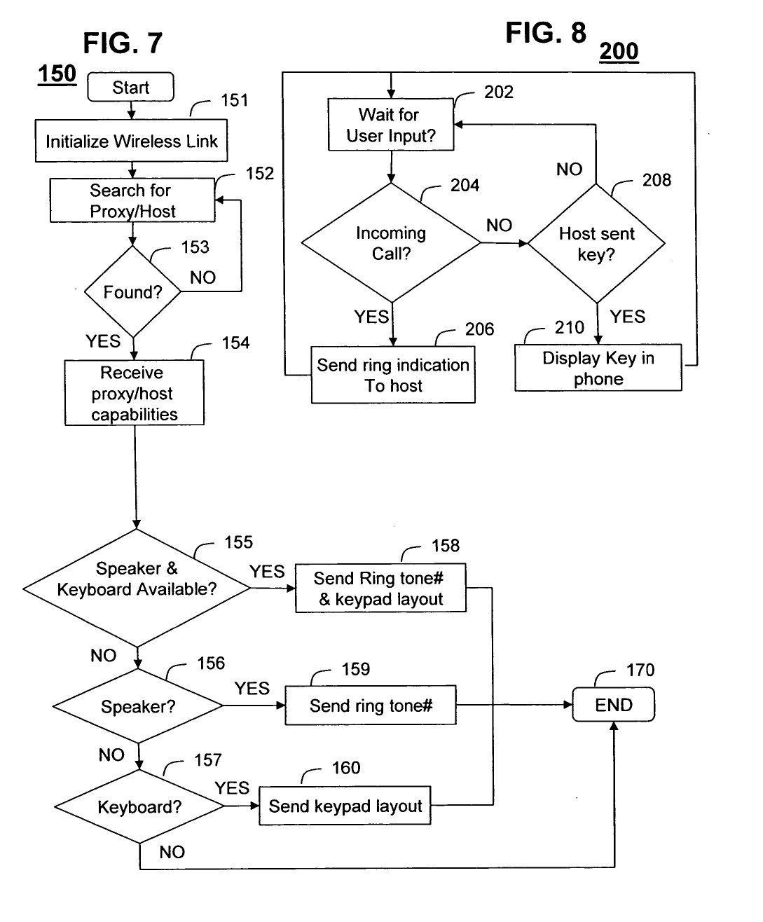

Referring to FIGS. 7 and 8, flow charts illustrate power saving methods 150 and 200 by a host device and a phone in accordance with an embodiment of the present invention. A wireless link can be initialized at step 151 between the host device (such as a personal computer) and a phone and a search for the host is started at step 151. At decision block 153, the method 150 continues to search for the host and otherwise if the host is found, then proxy capabilities (such as keyboards, speakers available, microphones, displays, etc.) are received by the host at step 154. Next, the method at decision blocks 155, 156 and 157 respectively determine if a speaker and keyboard is available or if a speaker alone is available or if a keyboard is available. If none of the host capabilities are available, the method ends at step 170. If both are available, then a particular ring tone number and a keypad layout can be sent by the phone and received by the host at step 158. If just a speaker capability is available, then a ring tone number can be sent by the phone and received by the host at step 159. If just the keyboard capability is available, then the phone sends the keypad layout to the host at step 160. Referring to FIG. 8, the method 200 then awaits for user input at step 202. If the phone receives an incoming call at decision block 204, then the phone sends a ring indication to the host at step 206 and then returns to step 202 to wait for additional input. If no incoming call is detected at decision block 204, then the phone can determine if the host sent a key at decision block 208. If no key is sent at decision block 204, then the method 200 continues to wait for additional input at step 202. If the host sends a key at decision block 208, then the corresponding key can be activated at the phone during step 210.

While the specification concludes with claims defining the features of embodiments of the invention that are regarded as novel, it is believed that the invention will be better understood from a consideration of the following description in conjunction with the figures, in which like reference numerals are carried forward.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A power saving method in a wireless device having a short range communication link with a host device, comprising the steps of:
establishing the short range communication link with the host device;
establishing at least one function of the wireless device in the host device; and
transferring the at least one function of the wireless device to the host device upon a predetermined event if a power saving opportunity is determined.

2. The method of claim 1, wherein the method further comprises the step of processing the at least one function at the host device.

3. The method of claim 1, wherein the method further comprises the step of retaining the at least one function at the wireless device if no power saving opportunity is determined.

4. The method of claim 3, wherein the method further comprises the step of processing the at least one function at the wireless device.

5. The method of claim 1, wherein the method further comprises the step of sending a request by the wireless device to the host device for handling the predetermined event and transferring the at least one function if the request is accepted.

6. The method of claim 1, wherein the method further comprises the step of establishing at least one function of the wireless device with two or more host devices.

7. The method of claim 6, wherein the method further comprises the step of determining which of the two or more host devices are most capable of processing the at least one function.

8. The method of claim 1, wherein the method further comprises the step of transferring the at least one function from the host device back to the wireless device once the wireless device is out of range of the short range communication link with the host device.

9. A wireless device, comprising:
a transceiver for a short range communication link with a host device; and
a processor coupled to the transceiver, wherein the processor is programmed to:
establish the short range communication link with the host device;
establish at least one function of the wireless device in the host device; and
transfer the at least one function of the wireless device to the host device upon a predetermined event if a power saving opportunity is determined.

10. The wireless device of claim 9, wherein the processor is further programmed to enable the processing of the at least one function at the host device.

11. The wireless device of claim 9, wherein the processor is further programmed to retain the at least one function at the wireless device if no power saving opportunity is determined.

12. The wireless device of claim 11, wherein the processor is further programmed to process the at least one function at the wireless device.

13. The wireless device of claim 9, wherein the processor is further programmed to send a request to the host device to handle the predetermined event and transfer the at least one function if the request is accepted by the host device.

14. The wireless device of claim 9, wherein the processor is further programmed to establish at least one function of the wireless device with two or more host devices.

15. The wireless device of claim 14, wherein the processor is further programmed to determine which of the two or more host devices are most capable of processing the at least one function.

16. The wireless device of claim 9, wherein the wireless device is selected among the group comprising a cellular phone, a two-way pager, a messaging device, a trunked radio, a smart phone, a satellite phone, a laptop computer, a portable home appliance, a portable personal hygiene appliance, or any combination thereof.

17. The wireless device of claim 9, wherein the transceiver for the short range communication link with the host device comprises at least one among a Bluetooth communication link, an infrared communication link, or an 802.15.4 communication link.

18. The wireless device of claim 9, wherein the host device is selected among the group comprising a personal computer, a vehicle, or an electronic device coupled to a fixed power source, wherein each of the host devices has at least one function capability among audio, display, and user input.

19. The wireless device of claim 9, wherein the processor is further programmed to enable the transfer of the at least one function from the host device back to the wireless device once the wireless device is out of range of the short range communication link with the host device.

20. A power saving system for a portable electronic product, comprising:
a transceiver for a short range communication link with a host device; and
a processor coupled to the transceiver, wherein the processor is programmed to:
establish the short range communication link between the portable electronic product and the host device;
establish at least one function of the portable electronic product in the host device; and
transfer the at least one function of the portable electronic product to the host device upon a predetermined event if a power saving opportunity is determined.
